(19) United States
(12) Patent Application Publication
(10) Pub. No.: US 2023/0044087 A1
(43) Pub. Date: Feb. 9, 2023

(54) USING LOCAL GEOMETRY WHEN CREATING A NEURAL NETWORK

(71) Applicant: Yaim Cooper, Princeton, NJ (US)

(72) Inventor: Yaim Cooper, Princeton, NJ (US)

(21) Appl. No.: 17/817,922

(22) Filed: Aug. 5, 2022

Related U.S. Application Data
(63) Continuation-in-part of application No. 17/396,259, filed on Aug. 6, 2021.

(51) Int. Cl. G06N 3/08; G06K 9/62

(52) U.S. Cl. CPC G06N 3/08; G06K 9/6262

(57) ABSTRACT

A computer system (which may include one or more computers) that chooses or selects one or more criteria for when to terminate training of a neural network is described. During operation, the computer system may choose or select the one or more criteria for when to terminate the training of the neural network, where the one or more criteria are based at least in part on a measure corresponding to a local geometry of a loss landscape at or proximate to a current location in the loss landscape. Note that one of the one or more criteria may include: a trace of a Hessian matrix associated with a loss function dropping below a threshold, or a ratio between an operator norm of the Hessian matrix and a curvature of the loss function at the current location in the loss landscape reaching a second threshold.

### CROSS REFERENCE TO RELATED APPLICATIONS

This application is a Continuation-in-Part of U.S. patent application Ser. No. 17/396,259, entitled “Training and Generalization of a Neural Network,” by Yaim Cooper, filed on Aug. 6, 2021, the contents of which are herein incorporated by reference.

### FIELD

The described embodiments relate to training of a neural network, including initialization, termination of training and/or evaluation of a trained neural network based at least in part on a measure corresponding to a local geometry of a loss function at or proximate to a current location in a loss landscape.

### BACKGROUND

In a feedforward artificial neural network (which is sometimes referred to as a ‘neural network’), layers of nonlinear neurons in hidden layers are often used between the inputs and the outputs. This neural network undergoes ‘training,’ during which a weight is determined for each unit. Moreover, during the training, the neural network processes training data. This training data may include a collection of inputs and corresponding known outputs. Typically, the intent is for the neural network to ‘learn,’ by generalizing the information present in the training data, so that the neural network can assign outputs to inputs that are not present in the training data. Note that the training process is usually governed by a set of hyperparameters, which are often chosen before training commences. The hyperparameters are typically either fixed or follow a predefined schedule or predefined scaling during the training. After the training has been completed, the results of the learning are often assessed by using the neural network to evaluate a validation data. Moreover, after this validation, the neural network may evaluate test data, such as data for which the neural network can generate outputs.

Furthermore, a system training the neural network may set up the training process, terminate the training process and, afterwards, evaluate a quality of the trained neural network. For example, setting up the training process may involve choosing a set of initial values for the weights in the neural network, terminating the training process may involve choosing a set of one or more criteria for when to end training, and evaluating the quality of the trained neural network may involve assessing the performance of the neural network on a held-out test data set.

During training, the goal is to progressively change the weights on connections coming into the neurons in such a way that the neural network learns to produce the correct output when given an input in the training data. Often, this is performed using gradient-descent-based techniques to minimize a function L: R^{d}→R, called the ‘loss function,’ which measures the training error of the neural network. Geometrically, the loss function L may determine or specify a loss landscape. During training, the neural network traverses this loss landscape, looking for the best minimum in this loss landscape. Let Min denote the set of all minima in the loss landscape. Note that some of the minima may be local minima at which the training error or loss is much larger than zero. However, other minima may be global minima at which the training error or loss is zero or near zero.

Let M denote the set of all global minima in the loss landscape. For any parameter vector in or near M (such as a set of weights for the connections coming into the neurons), the neural network using this parameter vector will have zero or near zero training error. However, many of the parameter vectors in or near M may perform more poorly on the test data than on the training data. This is because the neurons in the neural network may have been trained to work well on the training data, but not on the test data. When a parameter vector performs well on both the training data and test data, it is said to generalize well. The goal in machine learning is to traverse the loss landscape to find parameter vectors that not only lie in or near M but that also generalize well. In other words, the goal of the training is to find a parameter vector that achieves or has low test loss or test error.

This overall goal may be restated as two primary aims when training a neural network. The first, which is referred to as an ‘optimization problem,’ involves traversing the loss landscape to find a parameter vector in or near the set of global minima M. The second, which is referred to as a ‘generalization problem,’ involves finding a parameter vector among the parameter vectors in or near M (which may all have zero or near error on the training data) that achieves low test loss.

In general, the optimization problem may become increasingly tractable, and the generalization problem may become increasingly difficult, as the complexity of the neural network increases. In principle, generalization can be improved by enlarging the size of the training data. However, it is time-consuming and expensive to collect more training data, and the use of more training data may increase the time and cost of training a neural network.

### SUMMARY

In a first group of embodiments, a computer system (which may include one or more computers) that trains a neural network is described. This computer system includes: a computation device; and memory that stores program instructions. When executed by the computation device, the program instructions cause the computer system to perform one or more operations. Notably, during operation of the computer system, the computer system trains the neural network based at least in part on a set of hyperparameters, where the training includes computing weights associated with neurons in the neural network. Moreover, during the training, the computer system dynamically adapts one or more first hyperparameters in the set of hyperparameters based at least in part on a measure corresponding to a local geometry of a loss landscape at or proximate to a current location in the loss landscape. Note that the dynamic adapting based at least in part on the measure is separate from or in addition to a predefined adaptation of one or more second hyperparameters the set of hyperparameters based on a predefined number of iterations or cycles in the training or a predefined scaling factor.

In some embodiments, the one or more first hyperparameters may be the same as the one or more second hyperparameters or, at least in part, different from the one or more second hyperparameters.

Moreover, the operations may include computing values of a loss function at or proximate to the current location based at least in part on one or more outputs from the neural network. Note that the loss function may include a training error of the neural network and the computed values of the loss function may specify the loss landscape at or proximate to the current location.

Furthermore, the set of hyperparameters may include one or more of: a type or variation of stochastic gradient descent, a type of gradient, a batch size, a learning rate or a step size, the loss function, or a regularizing term in the loss function. In some embodiments, the set of hyperparameters may include: a continuous-valued hyperparameter having a continuous range of values and/or a discrete hyperparameter having a discrete value.

Note that the measure may include: a slope at the current location along one or more dimensions in the loss landscape, and/or a curvature at the current location along the one or more dimensions in the loss landscape. For example, the slope may include the derivative or a batched gradient at the current location. In some embodiments, the measure may include or may be an approximation to: a slope associated with the loss function, a norm of a gradient, a norm of a directional derivative, and/or a first order measure of the local geometry. Alternatively or additionally, the measure may include or may be an approximation to: a Hessian matrix associated with the loss function, a trace of the Hessian matrix, an eigenvalue of the Hessian matrix, and/or an operator norm of the Hessian matrix. In some embodiments, the measure may include or may be an approximation to: a partial derivative or set of partial derivatives associated with the loss function, a partial difference or set of partial differences associated with the loss function, a function computed from a set of inputs that may include partial derivatives or partial differences, a quantity computed from local parameters (such as local coordinates or local equations of the loss landscape) using integrals in conjunction with at least another embodiment of the measure, and/or a function computed from the local parameters via numerical integration techniques.

Moreover, the one or more first hyperparameters in the set of hyperparameters may be dynamically adapted each N iterations or cycles during the training, where Nis a non-zero integer.

For example, the one or more first hyperparameters may be dynamically adapted when a magnitude of change in the loss function, which specifies the loss landscape, is less than a predefined amount in a preceding predefined number of iterations or cycles in the training. When the magnitude of the change in the loss function is less than the predefined amount in the preceding predefined number of iterations or cycles in the training, the dynamic adapting of the one or more first hyperparameters may include increasing the step size or the learning rate (e.g., for at least the subsequent N iterations or cycles in the training, where N is a non-zero integer).

Another embodiment provides a computer for use, e.g., in the computer system.

Another embodiment provides a computer-readable storage medium for use with the computer or the computer system. When executed by the computer or the computer system, this computer-readable storage medium causes the computer or the computer system to perform at least some of the aforementioned operations.

Another embodiment provides a method, which may be performed by the computer or the computer system. This method includes at least some of the aforementioned operations.

In a second group of embodiments, a computer system (which may include one or more computers) that chooses or selects one or more criteria for when to terminate training of a neural network is described. This computer system includes: a computation device; and memory that stores program instructions. When executed by the computation device, the program instructions cause the computer system to perform one or more operations. Notably, during operation of the computer system, the computer system chooses or selects the one or more criteria for when to terminate the training of the neural network, where the one or more criteria are based at least in part on a measure corresponding to a local geometry of a loss landscape at or proximate to a current location in the loss landscape.

Note that one of the one or more criteria may include: a trace of a Hessian matrix associated with a loss function decreasing below or is less than a threshold, or a ratio between an operator norm of the Hessian matrix and a curvature of the loss function at the current location in the loss landscape reaching or exceeding a second threshold. In some embodiments, the one or more criteria may include or may be an approximation to: a partial derivative or set of partial derivatives associated with the loss function, a partial difference or set of partial differences associated with the loss function, a function computed from a set of inputs that may include partial derivatives or partial differences, a quantity computed from local parameters (such as local coordinates or local equations of the loss landscape) using integrals in conjunction with at least another embodiment of the one or more criteria, and/or a function computed from the local parameters via numerical integration techniques.

Moreover, the operations may include computing values of the loss function at or proximate to the current location based at least in part on one or more outputs from the neural network. Note that the loss function may include a training error of the neural network and the computed values of the loss function may specify the loss landscape at or proximate to the current location.

Furthermore, the measure may include: a slope at the current location along one or more dimensions in the loss landscape, and/or a curvature at the current location along the one or more dimensions in the loss landscape. For example, the slope may include the derivative or a batched gradient at the current location. In some embodiments, the measure may include or may be an approximation to: a slope associated with the loss function, a norm of a gradient, a norm of a directional derivative, and/or a first order measure of the local geometry. Alternatively or additionally, the measure may include or may be an approximation to: the Hessian matrix associated with the loss function, the trace of the Hessian matrix, an eigenvalue of the Hessian matrix, and/or an operator norm of the Hessian matrix.

Additionally, the operations may include running or performing processes before and after training, including initializing the neural network, determining the one or more criterial, and/or evaluating a quality of the neural network after training. These processes may be based at least in part on the measure corresponding to the local geometry of the loss landscape at or proximate to the current location in the loss landscape.

Another embodiment provides a computer for use, e.g., in the computer system.

Another embodiment provides a computer-readable storage medium for use with the computer or the computer system. When executed by the computer or the computer system, this computer-readable storage medium causes the computer or the computer system to perform at least some of the aforementioned operations.

Another embodiment provides a method, which may be performed by the computer or the computer system. This method includes at least some of the aforementioned operations.

In a third group of embodiments, a computer system (which may include one or more computers) that initializes weights for a neural network is described.

In a fourth group of embodiments, a computer system (which may include one or more computers) that evaluates a trained neural network is described.

In any of the preceding groups of embodiments, a given one of the one or more criteria, thresholds or ranges may be absolute, or they may be scaled as appropriate to the architecture and size of the neural network.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of a computer system in accordance with an embodiment of the present disclosure.

FIGS. 2-3 are drawings illustrating examples of training error and test error during training of a neural network.

FIG. 4 is a flow diagram illustrating an example of a method for training a neural network using a computer system in FIG. 1 in accordance with an embodiment of the present disclosure.

FIG. 5 is a flow diagram illustrating an example of a method for training a neural network using a computer system in FIG. 1 in accordance with an embodiment of the present disclosure.

FIG. 6 is a drawing illustrating an example of communication between components in a computer system in FIG. 1 in accordance with an embodiment of the present disclosure.

FIG. 7 is a drawing illustrating an example of training a neural network using a computer system in FIG. 1 in accordance with an embodiment of the present disclosure.

FIG. 8 is a drawing illustrating an example of training a neural network using a computer system in FIG. 1 in accordance with an embodiment of the present disclosure.

FIG. 9 is a block diagram illustrating an example of a computer in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In a first group of embodiments, a computer system (which may include one or more computers) that trains a neural network is described. During operation, the computer system may train the neural network based at least in part on a set of hyperparameters, where the training includes computing weights associated with neurons in the neural network. Moreover, during the training, the computer system may dynamically adapt one or more first hyperparameters in the set of hyperparameters based at least in part on a measure corresponding to a local geometry of a loss landscape at or proximate to a current location in the loss landscape. Note that the dynamic adapting based at least in part on the measure is separate from or in addition to a predefined adaptation of one or more second hyperparameters the set of hyperparameters based on a predefined number of iterations or cycles in the training or a predefined scaling factor.

By dynamically adapting the one or more first hyperparameters in the set of hyperparameters during the training of the neural network, these training techniques may improve the training and/or the performance of the neural network. Notably, the training techniques may reduce the time, cost and/or complexity of the training. For example, the training techniques may enable the neural network to be trained using less training data relative to existing training techniques. Moreover, the training techniques may allow the neural network to traverse the loss landscape to find one or more parameter vectors (with a set of weights for the connections coming into the neurons in the neural network) that have zero or near zero error on the training data and that achieve low test loss or test error (and, thus, which generalize well). Consequently, the training techniques may improve the quality and the accuracy of the neural network.

In a second group of embodiments, a computer system (which may include one or more computers) that chooses or selects one or more criteria for when to terminate training of a neural network is described. During operation, the computer system may choose or select the one or more criteria for when to terminate the training of the neural network, where the one or more criteria are based at least in part on a measure corresponding to a local geometry of a loss landscape at or proximate to a current location in the loss landscape. Note that one of the one or more criteria may include: a trace of a Hessian matrix associated with a loss function decreasing below a threshold, or a ratio between an operator norm of the Hessian matrix and a curvature of the loss function at the current location in the loss landscape reaching a second threshold.

By choosing or selecting the one or more criteria, these training techniques may improve the training and/or the performance of the neural network. Notably, the training techniques may reduce the time, cost and/or complexity of the training. For example, the training techniques may result in the training process terminating or ending with a set of weights for the neural network that provide improved performance, and may improve or optimize the amount of time spent training the neural network.

In the discussion that follows, the training techniques are used to train embodiments of a neural network. Note that the neural network may include a wide variety of neural network architectures and configurations, including: a convolutional neural network, a recurrent neural network, an autoencoder neural network, a perceptron neural network, a feed forward neural network, a radial basis neural network, a deep feed forward neural network, a long/short term memory neural network, a gated recurrent unit neural network, a variational autoencoder neural network, a denoising neural network, a sparse neural network, a Markov chain neural network, a Hopfield neural network, a Boltzmann machine neural network, a restricted Boltzmann machine neural network, a deep belief neural network, a deep convolutional neural network, a deconvolutional neural network, a deep convolutional inverse graphics neural network, a generative adversarial neural network, a liquid state machine neural network, an extreme learning machine neural network, an echo state neural network, a deep residual neural network, a Kohonen neural network, a support vector machine neural network, a neural turing machine neural network, or another type of neural network (which may, at least, include: an input layer, one or more hidden layers, and an output layer). However, more generally, the training techniques may be used with a variety of machine-learning techniques to train other types of classifier or regression models. For example, a classifier or a regression model may be training using the training techniques in conjunction with a supervised-learning technique, including: a support vector machine technique, a classification and regression tree technique, logistic regression, LASSO, linear regression, and/or another linear or nonlinear supervised-learning technique. Alternatively, in other embodiments, classifier or a regression model may be training using the training techniques in conjunction with an unsupervised-learning technique, such as a type of clustering.

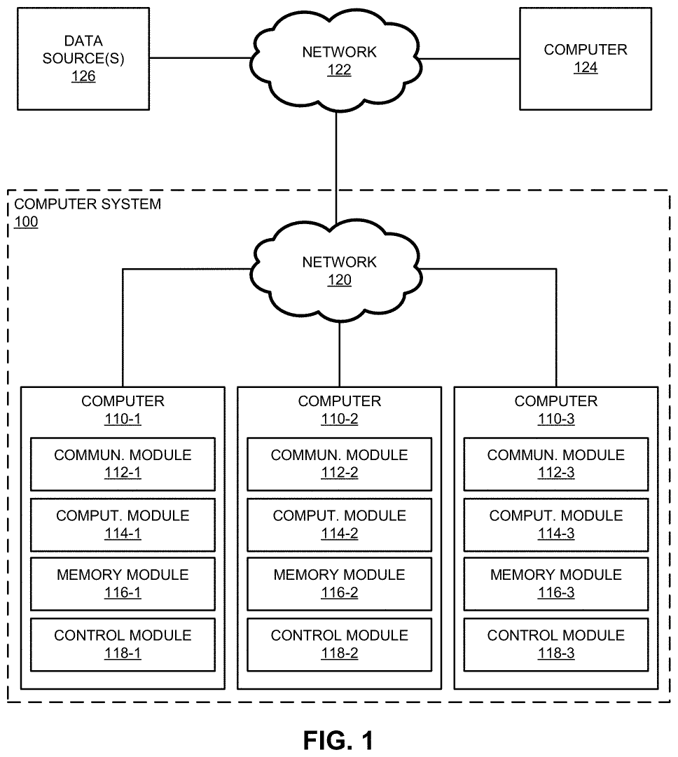

We now describe embodiments of the training techniques. FIG. 1 presents a block diagram illustrating an example of a computer system 100. This computer system may include one or more computers 110. These computers may include: communication modules 112, computation modules 114, memory modules 116, and optional control modules 118. Note that a given module or engine may be implemented in hardware and/or in software.

Communication modules 112 may communicate frames or packets with data or information (such as training data, test data or control instructions) between computers 110 via a network 120 (such as the Internet and/or an intranet). For example, this communication may use a wired communication protocol, such as an Institute of Electrical and Electronics Engineers (IEEE) 802.3 standard (which is sometimes referred to as ‘Ethernet’) and/or another type of wired interface. Alternatively or additionally, communication modules 112 may communicate the data or the information using a wireless communication protocol, such as: an IEEE 802.11 standard (which is sometimes referred to as ‘Wi-Fi’, from the Wi-Fi Alliance of Austin, Tex.), Bluetooth (from the Bluetooth Special Interest Group of Kirkland, Wash.), a third generation or 3G communication protocol, a fourth generation or 4G communication protocol, e.g., Long Term Evolution or LTE (from the 3^{rd} Generation Partnership Project of Sophia Antipolis, Valbonne, France), LTE Advanced (LTE-A), a fifth generation or 5G communication protocol, other present or future developed advanced cellular communication protocol, or another type of wireless interface. For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies.

In the described embodiments, processing a packet or a frame in a given one of computers 110 (such as computer 110-1) may include: receiving the signals with a packet or the frame; decoding/extracting the packet or the frame from the received signals to acquire the packet or the frame; and processing the packet or the frame to determine information contained in the payload of the packet or the frame. Note that the communication in FIG. 1 may be characterized by a variety of performance metrics, such as: a data rate for successful communication (which is sometimes referred to as ‘throughput’), an error rate (such as a retry or resend rate), a mean squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). Note that wireless communication between components in FIG. 1 uses one or more bands of frequencies, such as: 900 MHz, 2.4 GHz, 5 GHz, 6 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. In some embodiments, the communication between the components may use multi-user transmission (such as orthogonal frequency division multiple access or OFDMA).

Moreover, computation modules 114 may perform calculations using: one or more microprocessors, ASICs, microcontrollers, programmable-logic devices, GPUs and/or one or more digital signal processors (DSPs). Note that a given computation component is sometimes referred to as a ‘computation device’.

Furthermore, memory modules 116 may access stored data or information in memory that local in computer system 100 and/or that is remotely located from computer system 100. Notably, in some embodiments, one or more of memory modules 116 may access stored training data and/or test data in the local memory. Alternatively or additionally, in other embodiments, one or more memory modules 116 may access, via one or more of communication modules 112, stored training data and/or test data in the remote memory in computer 124, e.g., via network 120 and network 122. Note that network 122 may include: the Internet and/or an intranet. In some embodiments, the training data and/or the test data may include data or measurement results that are received from one or more data sources 126 (such as cameras, environmental sensors, servers associated with social networks, email servers, etc.) via network 120 and network 122 and one or more of communication modules 112. Thus, in some embodiments at least some of the training data and/or the test data may have been received previously and may be stored in memory, while in other embodiments at least some of the training data and/or the test data may be received in real time from the one or more data sources 126 (e.g., as the training of the neural network is performed).

While FIG. 1 illustrates computer system 100 at a particular location, in other embodiments at least a portion of computer system 100 is implemented at more than one location. Thus, in some embodiments, computer system 100 is implemented in a centralized manner, while in other embodiments at least a portion of computer system 100 is implemented in a distributed manner. For example, in some embodiments, the one or more data sources 126 may include local hardware and/or software that performs at least some of the operations in the training techniques. This remote processing may reduce the amount of training data and/or the test data that is communicated via network 120 and network 122. In addition, the remote processing may anonymize the data that are communicated to and analyzed by computer system 100. This capability may help ensure computer system 100 is secure and maintains privacy of individuals, who may be associated with the training data and/or the test data. For example, computer system 100 may be compatible and compliant with regulations, such as the Health Insurance Portability and Accountability Act, e.g., by removing or obfuscating protected health information in the data.

Although we describe the computation environment shown in FIG. 1 as an example, in alternative embodiments, different numbers or types of components may be present in computer system 100. For example, some embodiments may include more or fewer components, a different component, and/or components may be combined into a single component, and/or a single component may be divided into two or more components.

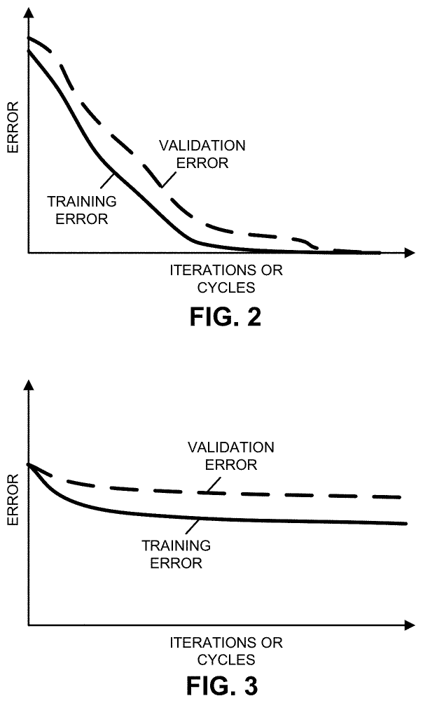

As discussed previously, existing training techniques may have difficulty solving the optimization problem and the generalization problem. Moreover, as described further below with reference to FIGS. 2-8, in order to address these challenges computer system 100 may perform the training techniques. Notably, during the training techniques, one or more of optional control modules 118 may divide the training of the neural network among computers 110. Then, a given computer (such as computer 110-1) may perform at least a designated portion of the training of the neural network.

Notably, computation module 114-1 may access information (e.g., using memory module 116-1) specifying: training data, test data and/or validation data (such as images with known classifications, speech-recognition data, object-recognition data, etc.), an architecture or configuration of the neural network (including a number of layers, a number of neurons, relationships or interconnections between neurons, activations functions, and/or weights), and an initial set of one or more hyperparameters governing the initial training of the neural network. For example, the neural network may include a feedforward neural network with multiple layers. Each of the layers include one or more neurons (which are sometimes referred to as ‘nodes’). A given neuron may have associated weights and activation functions (such as a rectified linear activation function or ReLU, a leaky ReLU, an exponential linear unit or ELU activation function, a parametric ReLU, a tanh activation function, or a sigmoid activation function) for each parameter input to the given neuron. In general, the output of a given neuron of layer i may be fed as input into one or more neurons in layer i+1. Based at least in part on the information, computation module 114-1 may implement some or all of the neural network.

Next, computation module 114-1 may perform the training of the neural network, which may involve iteratively computing values of the weights associated with the neurons in the neural network during iterations or cycles of the training. For example, the training may initially use a type or variation of stochastic gradient descent and a loss function of the L2 norm (or least square error) of the training error (the difference of an output of the neural network with a known output in the training data). Note that a loss landscape may be defined as values of the loss function for different weights associated with the neurons in the neural network. A given location in the loss landscape may correspond to particular values of the weights.

During the training of the neural network, the weights may evolve or change as the neural network traverses the loss landscape (a process that is sometimes referred to as ‘learning’). For example, the weights may be updated after one or more iteration or cycles of the training process, which, in some embodiments, may include updates to the weights in each iteration or cycle. In some embodiments, where minibatch stochastic gradient descent is used, there may be 128,000 training examples, and the batch size may be 128. At the beginning of one training epoch, the training examples may be randomly shuffled and then partitioned into 1,000 subsets of 128 data points each, where each subset constituting a minibatch. In one iteration or cycle, a partial or batch gradient may be computed based on the 128 data points in one minibatch. Moreover, in this example, one training epoch may include 1,000 iterations or cycles, and in one training epoch, each example in the training data set may contribute once to the training process. Note that a ‘training epoch’ may be defined as a number of iterations or cycles in which all the training data is evaluated once during the training, and the training of the neural network may include multiple training epochs.

Furthermore, in some embodiments hyperparameters may be updated every N iterations or cycles during the training of the neural network, where N is a non-zero integer (such as 1, 10, 100, 1,000 or 10,000). In the discussion that follows, N iterations or cycles is sometimes referred to as a ‘training era’ and one or more first hyperparameters in the set of hyperparameters may be dynamically updated in some or in each training era. Thus, the training of the neural network may include multiple training eras. In some embodiments, a training era may be longer than a training epoch, shorter than a training epoch, or the two may consist of the same number of iterations or cycles. Note also that the batch size may be dynamically updated during the training of the neural network, and therefore that the length of a training epoch may vary during training. In some embodiments, the length of a training era may also be chosen to vary during the process of training the neural network. Therefore, the relative lengths of a training era and a training epoch may also vary during training of the neural network.

Challenges that can arise during training are illustrated in FIGS. 2-3, which present drawings illustrating examples of training error or loss and validation error or loss during training of a neural network. Notably, FIG. 2 illustrates a scenario in which the training error plateaus near zero, but the validation loss continues to decrease. This phase of the training can be computationally expensive. Moreover, FIG. 3 illustrates a scenario in which the training error or loss plateaus at a non-zero value because the training has gotten stuck (e.g., because of a critical point in the loss landscape). In this situation, the training is typically terminated and then restarted from the beginning.

Referring back to FIG. 1, some existing training techniques attempt to address the training problems by using a fixed or predefined schedule of changes to one or more hyperparameters in the set of hyperparameters. For example, the one or more of the hyperparameters in the set of hyperparameters may be changed after a predefined number of iterations or cycles during the training of a neural network (such as 1 million iterations or cycles). Alternatively or additionally, some existing training techniques may scale the one or more of the hyperparameters in the set of hyperparameters using a predefined scaling factor (such as 10) after the same or a different predefined number of iterations or cycles during the training of a neural network (such as 1 million-10 million iterations or cycles). In some existing training techniques other heuristics may be used. For example, existing training techniques may manually adjust a learning rate or a step size during the training of a neural network. Notably, an equal learning rate or step size (e.g., 0.01) may initially be used for all the layers in a neural network. When the training error rate or a validation error rate stops improving, the learning rate or step size may be divided or reduced by a factor of 10. After three instances of such a reduction in the learning rate or the step size, the training in the existing training techniques may be terminated or stopped.

However, as discussed previously, the existing training techniques may not properly address or may not optimally address the problems in training of neural networks and, in the process, may create additional problems. Moreover, even if a particular existing training technique is successful, it may only work for a particular neural network or a type of neural networks. Consequently, existing approaches for training neural networks are often more of an art form.

In the disclosed training techniques, these problems are addressed in a more rigorous manner. We leverage the observation that training processes determined by different sets of hyperparameters may have different properties when used in a given local geometry. In local geometries that share one characteristic, one training process may provide certain desirable properties, and in local geometries that share a different characteristic, a different training process may provide certain other desirable properties. By providing the capacity to tailor the training process to the specific characteristics of the local geometry of the loss landscape at each location along the training path by adjusting the one or more first hyperparameters, the disclosed training techniques may make it possible to train neural networks more rapidly, cheaply, and/or to obtain better results (e.g., improved accuracy or predictions).

One or more measures of the local geometry of the loss landscape may be used to dynamically adapt one or more hyperparameters in the set of hyperparameters as the neural network dynamically traverses the loss landscape during the training of the neural network. These training techniques may be automated (e.g., without human or manual intervention), flexible and general-purpose, so that the training of the neural network can more rapidly and reliable converge on a solution for the weights where the training error is zero or approximately zero, and that generalizes well to the test data and the validation data.

Consequently, computation module 114-1 may dynamically adapt one or more first hyperparameters in the set of hyperparameters based at least in part on a measure corresponding to a local geometry of a loss landscape at or proximate to a current location in the loss landscape (as specified by current values of the weights). Moreover, the dynamic adapting based at least in part on the measure may be separate from or in addition to a predefined adaptation of one or more second hyperparameters the set of hyperparameters based on a predefined number of iterations or cycles in the training or a predefined scaling factor. Thus, in some embodiments, the disclosed training techniques may be used in conjunction with or to supplement one or more existing training techniques. However, in other embodiments, the disclosed training techniques is used instead of existing training techniques. Note that the one or more first hyperparameters may be the same as the one or more second hyperparameters or, in whole or in part, different from the one or more second hyperparameters.

A wide variety of measures of the local geometry may be used. For example, the measure may include: a slope at the current location along one or more dimensions in the loss landscape, and/or a curvature at the current location along the one or more dimensions in the loss landscape. For example, the slope may include the derivative or a batched gradient (along the one or more dimensions of the loss landscape) at the current location. In some embodiments, the measure may include or may be an approximation to: a slope associated with a loss function, a norm of a gradient, a norm of a directional derivative, and/or a first order measure of the local geometry. Alternatively or additionally, the measure may include or may be an approximation to: a Hessian matrix associated with a loss function, a trace of the Hessian matrix, an eigenvalue of the Hessian matrix, and/or an operator norm of the Hessian matrix. In some embodiments, the measure may include or may be an approximation to: a partial derivative or set of partial derivatives associated with the loss function, a partial difference or set of partial differences associated with the loss function, a function computed from a set of inputs that may include partial derivatives or partial differences, a quantity computed from local parameters (such as local coordinates or local equations of the loss landscape) using integrals in conjunction with at least another embodiment of the measure, and/or a function computed from the local parameters via numerical integration techniques.

As an example, stagnation in the change of the loss function along the path of training may correspond to a decrease in the slope of the loss function locally. Therefore, stagnation in the change of the loss function along the path of training may be used as a signal or criterion for modifying hyperparameters. For example, the one or more first hyperparameters may be dynamically adapted when a magnitude of change in a loss function, which specifies the loss landscape, is less than a predefined amount in a preceding predefined number of iterations or cycles in the training. When the magnitude of the change in the loss function is less than the predefined amount in the preceding predefined number of iterations or cycles in the training, the dynamic adapting of the one or more first hyperparameters may include increasing the step size or the learning rate (e.g., for at least the subsequent N iterations or cycles in the training, where Nis a non-zero integer, such as 10, 100 or 1000).

In general, the set of hyperparameters may include: a continuous-valued hyperparameter having a continuous range of values and/or a discrete hyperparameter having a discrete value. For example, the set of hyperparameters may include one or more of: a type or variation of stochastic gradient descent, a type of gradient, a batch size, a learning rate or a step size, a loss function, or a regularizing term in the loss function. Moreover, the one or more first hyperparameters in the set of hyperparameters may be dynamically adapted once every training era or once each N iterations or cycles during the training, where N is a non-zero integer (such as 1, 10, 100, 1,000 or 10,000).

Using the earlier example in which the loss function was initially the L2 norm of the training error, during the dynamic adapting, when there is stagnation in the change of the loss function, computation module 114-1 may change the loss function to an L1 norm (or least absolute deviation) of the training error.

The aforementioned operations in the training techniques may be iteratively repeated until a convergence criterion is achieved (such as a training error of approximately zero, plus a validation error of approximately zero) or a timeout of the training of the neural network (such as a maximum training time of 5-10 days). Moreover, after completing the training of the neural network (including evaluation using the test data and/or validation data), control module 118-1 may store results of the training of the neural network (e.g., the weights, the training error, the test error, etc.) in memory module 116-1. Alternatively or additionally, control module 118-1 may instruct communication module 114-1 to communicate results of the training of the neural network with other computers 110 in computer system 100 or with computers (not shown) external to computer system 100. This may allow the results from different computers 110 to be aggregated. In some embodiments, control module 118-1 may display at least a portion of the results, e.g., to an operator of computer system 100, so that the operator can evaluate the training of the neural network.

In some embodiments, a measure of the local geometry of the loss function may be used to inform the stopping time of the training process. Notably, computer system 100 may choose or select one or more criteria for when to terminate the training of the neural network. This may involve dynamically computing the one or more criteria and/or selecting one or more predefined or predetermined criteria. For example, the one or more criteria for when to terminate the training process may include: the training loss drops below or is less than a threshold and that at least 60% of the eigenvalues of the Hessian matrix of the loss function drops below or is less than a second threshold (such as a value between 0.1 and 10). Alternatively or additionally, the one or more criteria for when to terminate the training process may include: when the training loss drops below or is less than a threshold, the training is terminated when at least S subsequent steps (which are taken after the training loss is less than the threshold, where S is a non-zero integer) and the trace of the Hessian matrix of the loss function drops below or is less than a second threshold (such as a value between 0.01 and 1 times the dimension of the loss surface).

More generally, a measure corresponding to a local geometry of a loss function at or proximate to a current location in a loss landscape may be used to inform processes at the start and/or the end of training, such as initializing or setting up of the training process, the termination of the training process, and/or the evaluation of the trained neural network (e.g., after the training process has been terminated).

In some embodiments, before initiating training, computer system 100 may create a neural network that can be trained by populating a prototype with initial weights. The measure corresponding to the local geometry of the loss landscape at or proximate to the current location in the loss landscape may be used to evaluate potential initializations or starting points of the training process, and/or may inform the choice to discard certain initializations in favor of re-initializing. Moreover, computer system 100 may determine the one or more criteria for termination. Furthermore, after termination of the training, computer system 100 may output, along with the trained neural network, a quality rating or confidence rating for the neural network, where the quality rating or confidence rating may correspond to the measure (e.g., the quality rating or confidence rating may be based at least in part on the measure).

For example, the initial weights during initialization of a neural network may be selected and the measure of the local geometry of the loss landscape at the location specified by the initial weights may be computed. Notably, prior to the training, computer system 100 may select from a set of potential initializations by discarding those that do not meet one or more predefined conditions. In particular, when the measure does not satisfy one or more predefined conditions, the initialization may be discarded and the neural network may be re-initialized. The one or more conditions may include at the current location in the loss landscape: having a larger number of positive eigenvalues of a Hessian matrix than a threshold (such as 40% of a total number of eigenvalues of the Hessian matrix), a distribution of eigenvalues of the Hessian matrix falling within a range, confirming whether a set of nearby computed gradients satisfy predefined properties (such as that at least half of the gradients sampled have a magnitude of at least 10), a magnitude of a largest positive eigenvalue of the Hessian matrix being greater than a magnitude of a largest negative eigenvalue of the Hessian matrix and/or one or more conditions on a nearby curvature of the loss landscape. These initialization operations may be repeated until an initialization with good properties in the local geometry, with an above average probability of resulting in a good training phase, is selected.

While the preceding embodiments illustrated the initialization by discarding a possible initialization condition that does not meet one or more predefined conditions, in other embodiments the measure and/or the one or more predefined conditions may be used to update or change an initialization condition so that it does meet the one or more predefined conditions. Alternatively, instead of using the measure and/or the one or more predefined conditions for selection, in some embodiments the measure and/or the one or more predefined conditions are used to update or improve the initialization condition without performing selection of the initialization condition from a set of possible initialization condition. Thus, in general, the measure and/or the one or more predefined conditions may be used for selecting and/or updating or improving the initialization condition.

Consequently, in some embodiments of the initialization process, once the measure is computed, rather than the measure being used to determine whether to discard the initialization or not, the measure, or a second measure of the local geometry may be used to modify the initialization. The modified initialization may then be evaluated again by the computer system by computing the measure of the local geometry. One or more modification techniques may include: adding a random perturbation to one or more of the weights, the magnitude of which may be determined based at least in part on the second measure, or adding a non-random perturbation to the weights, the perturbation informed based at least in part by the second measure.

Furthermore, the measure of the local geometry of the loss landscape may be computed at the final location during training and may be used as the quality rating or confidence rating (where a lower value may indicate a better trained neural network). Alternatively or additionally, the measure of the local geometry of the loss landscape may be computed at the final location during training and may be combined with test data and may be used as the quality rating or confidence rating (where a larger value may indicate a better trained neural network). For example, the quality rating may be based at least in part on a ratio between an operator norm of a Hessian matrix and a curvature of the loss function at the current location in the loss landscape, or an average magnitude of the largest 10% of the eigenvalues of the Hessian matrix. In some embodiments, the measure of the local geometry of the loss landscape may be computed at the final location during training and may be combined with test data and measures of a decision boundary, which may be used as the quality rating or confidence rating (where a larger value may indicate a better trained neural network).

Thus, computer system 100 may set up the training process, terminate the training process, and/or evaluate the resulting trained neural network based at least in part on the measure corresponding to the local geometry of the loss landscape.

In these ways, computer system 100 may improve the training and/or the performance of the neural network. For example, the training techniques may enable the neural network to be trained using a less training data, with less training time, with reduced cost, and/or with reduced complexity. Thus, the training techniques may facilitate more-efficient optimization of neural networks. Moreover, the training techniques may improve the quality and the accuracy of the neural network, so that the trained neural network generalizes well to the test data and/or the validation data.

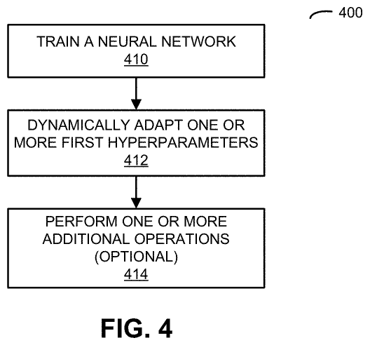

We now describe embodiments of the method. FIG. 4 presents a flow diagram illustrating an example of a method 400 for training a neural network, which may be performed by a computer system (such as computer system 100 in FIG. 1). During operation, the computer system may train the neural network (operation 410) based at least in part on a set of hyperparameters, where the training includes computing weights associated with neurons in the neural network.

Moreover, during the training, the computer system may dynamically adapt one or more first hyperparameters (operation 412) in the set of hyperparameters based at least in part on a measure corresponding to a local geometry of a loss landscape at or proximate to a current location in the loss landscape. Note that the dynamic adapting based at least in part on the measure is separate from or in addition to a predefined adaptation of one or more second hyperparameters the set of hyperparameters based on a predefined number of iterations or cycles in the training or a predefined scaling factor.

In some embodiments, the one or more first hyperparameters may be the same as the one or more second hyperparameters or, at least in part, different from the one or more second hyperparameters.

Furthermore, the set of hyperparameters may include one or more of: a type or variation of stochastic gradient descent, a type of gradient, a batch size, a learning rate or a step size, a loss function, or a regularizing term in the loss function. Additionally, the set of hyperparameters may include: a continuous-valued hyperparameter having a continuous range of values and/or a discrete hyperparameter having a discrete value.

Note that the measure used to inform changes to the set of hyperparameters may include: a slope at the current location along one or more dimensions in the loss landscape, and/or a curvature at the current location along the one or more dimensions in the loss landscape. For example, the slope may include the derivative or a batched gradient at the current location. In some embodiments, the measure may include or may be an approximation to: a slope associated with a loss function, a norm of a gradient, a norm of a directional derivative, and/or a first order measure of the local geometry. Alternatively or additionally, the measure may include or may be an approximation to: a Hessian matrix associated with a loss function, a trace of the Hessian matrix, an eigenvalue of the Hessian matrix, and/or an operator norm of the Hessian matrix. In some embodiments, the measure may include or may be an approximation to: a partial derivative or set of partial derivatives associated with the loss function, a partial difference or set of partial differences associated with the loss function, a function computed from a set of inputs that may include partial derivatives or partial differences, a quantity computed from local parameters (such as local coordinates or local equations of the loss landscape) using integrals in conjunction with at least another embodiment of the measure, and/or a function computed from the local parameters via numerical integration techniques.

In some embodiments, the computer system may optionally perform one or more additional operations (operation 414). For example, the computer system may iterate operations 410 and 412.

Moreover, the computer system may compute values of a loss function at or proximate to the current location based at least in part on one or more outputs from the neural network. Note that the loss function may include a training error of the neural network and the computed values of the loss function may specify the loss landscape at or proximate to the current location.

Furthermore, the one or more first hyperparameters may be dynamically adapted when a magnitude of change in a loss function, which specifies the loss landscape, is less than a predefined amount in a preceding predefined number of iterations or cycles in the training. When the magnitude of the change in the loss function is less than the predefined amount in the preceding predefined number of iterations or cycles in the training, the dynamic adapting of the one or more first hyperparameters may include increasing the step size or the learning rate (e.g., for at least the subsequent N iterations or cycles in the training, where N is a non-zero integer).

Additionally, the one or more first hyperparameters in the set of hyperparameters may be dynamically adapted once in each training era or every N iterations or cycles during the training, where Nis a non-zero integer.

In some embodiments, the dynamic adapting of the one or more first hyperparameters in the set of hyperparameters is performed by multiple subcontrollers, program instructions or program modules (or sets of program instructions) in the computer system. A given subcontroller, given program instructions or a given program module may be responsible for a different aspect of the training of the neural network. For example, a gradient subcontroller may govern the computation of the gradient for gradient descent, a step size subcontroller may govern the step size or the learning rate, a batch size subcontroller may govern the training batches, a loss function subcontroller may govern the primary term of the loss function used during training, and/or a regularizer subcontroller may govern one or more secondary terms of the loss function used during training.

One or more of the subcontrollers may include instances of control logic (which are sometimes referred to as ‘switches’). For example, each of the switches may enhance the efficiency of the training by modifying one or more of the first hyperparameters during the training of the neural network. However, in other embodiments, only one or two of the subcontrollers may include switches.

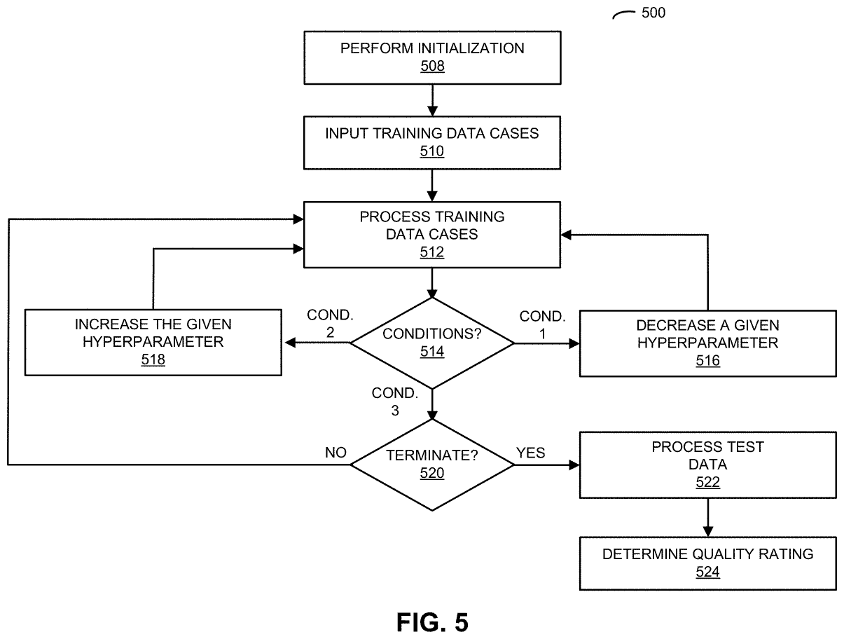

Operation of the switches is illustrated in FIG. 5, which presents a flow diagram illustrating an example of a method 500 for training a neural network. This method may be performed by a computer system (such as computer system 100 in FIG. 1).

Notably, an initialization switch (operation 508) may initially be in the off position or state. Prior to training the neural network, the initialization switch may be turned on, which starts the initialization process. This initialization process may be informed by one or more measures of the local geometry of the loss function. Once this process has been completed, the initialization switch may turn off again, and the training may commence.

During the training, the computer system may input (e.g., one at a time) training data cases (operation 510) to the neural network in order to train the neural network. Each training data case may be processed by the neural network (operation 512), e.g., in subgroups or subsets of the training data. After each N iterations or cycles during the training of the neural network, there may be an opportunity to toggle a given switch (such as: a switch associated with the gradient subcontroller; a switch associated with a step size subcontroller; a switch associated with a batch size subcontroller; and/or a switch associated with a loss function subcontroller). Notably, when one or more first predefined conditions occur (operation 514), such as when a threshold is reached, the given hyperparameter may be decreased (operation 516) or changed, e.g., a given switch may be turned on or activated. Alternatively, after the given switch has been activated and when one or more second predefined conditions occur (operation 514), such as when a threshold is not reached, the given hyperparameter may be increased (operation 518) or changed, e.g., the given switch may be turned off or deactivated. Otherwise (operation 514), the given hyperparameter may remain unchanged, e.g., the given switch may remain deactivated or, if the given switch was previously activated, then the given switch may remain activated. (While the preceding embodiment illustrated the training techniques by increasing or decreasing a hyperparameter, in other embodiments one or more hyperparameters may be changed in a way other than increasing or decreasing, such as by changing a type of gradient technique that is used during the training.)

Then, another subset of training cases may be processed (operation 512) and the loop may be repeated until a predefined criterion is met for the training to terminate (operation 520). At that point, the test data may then be optionally processed (operation 522) by the neural network.

In some embodiments, when a gradient switch is activated, the way the gradient is calculated during the training may be modified. Notably, when the gradient switch is deactivated, the gradient may be computed using, e.g., ADAM. However, when the gradient switch is activated, a fixed minimum vector length m may be specified (where m is a positive, non-zero real number). If the norm of the gradient is more than m, the gradient may be computed using ADAM. Alternatively, if the norm of the gradient is less than m, the gradient may be computed and then replaced by a normalized vector

$$\frac{m ∇ L}{‖ ∇ L ‖} ,$$

where L is the loss function. Once the gradient switch is set, another subset of training cases may be processed (operation 512) and the loop may be repeated until a predefined criterion is met for the training to terminate (operation 520). At that point, the test data may then be optionally processed by the neural network (operation 522). By selectively activating/deactivating the gradient switch in the gradient subcontroller, problematic critical point(s) during the training may be avoided or escaped, and/or, when near the locus of global minima, an optimum with better generalization may be found.

Moreover, when a step size switch is activated, the step size or the learning rate used during the training may be modified. Notably, when the step size switch is deactivated, the step size or the learning rate may be unchanged. However, when the step size switch is activated, a given one of multiple potential step size or learning rate modifications may be used. For example, the step size may be increased from η to a new step size \tilde{η}, which may be greater than η. Moreover, the ratio \tilde{η}/η may be predefined and fixed at the start of the training of the neural network, or \tilde{η} may be chosen every time the step size switch is activated, such as using a function of one or more measures, e.g., η, the average decrease in L over a previous period of iterations or cycles, the batch size, etc.

Alternatively, when the step size switch has been activated, under predefined conditions the step size switch may subsequently be deactivated. When this occurs, the step size may revert to η. Furthermore, once the step size switch is set, another subset of training cases may be processed (operation 512) and the loop may be repeated until a predefined criterion is met for the training to terminate (operation 520). At that point, the test data may then be optionally processed by the neural network (operation 522). By selectively activating/deactivating the step size switch in the step size subcontroller, problematic critical point(s) during the training may be avoided or escaped, and/or, when near the locus of global minima, an optimum with better generalization may be found.

Furthermore, when a batch size switch is activated, the batch size used during the training may be modified. Notably, when the batch size switch is deactivated, the batch size used in stochastic gradient descent may be unchanged. However, when the batch size switch is activated, a given one of multiple potential batch size modifications may be used. For example, the batch size may be decreased from b to a smaller batch size \tilde{b}.

Alternatively, when the batch size switch has been activated, under predefined conditions the batch size switch may subsequently be deactivated. When this occurs, the batch size may revert to b. Furthermore, once the batch size switch is set, another subset of training cases may be processed (operation 512) and the loop may be repeated until a predefined criterion is met for the training to terminate (operation 520). At that point, the test data may then be optionally processed by the neural network (operation 522). By selectively activating/deactivating the batch size switch in the batch size subcontroller, problematic critical point(s) during the training may be avoided or escaped, and/or, when near the locus of global minima, an optimum with better generalization may be determined.

Additionally, when a loss function switch is activated, a primary term of the loss function used during the training may be modified. Notably, when the loss function switch is deactivated, the loss function used during the training may be unchanged. However, when the loss function switch is activated, a given one of multiple potential loss function modifications may be used. For example, the loss function may be changed from an L2 norm loss function to an L1 norm loss function.

Alternatively, when the loss function switch has been activated, under predefined conditions the loss function switch may subsequently be deactivated. When this occurs, the loss function may revert to the original loss function. Furthermore, once the loss function switch is set, another subset of training cases may be processed (operation 512) and the loop may be repeated until a predefined criterion is met for the training to terminate (operation 520). At that point, the test data may then be optionally processed by the neural network (operation 522). By selectively activating/deactivating the loss function switch in the loss function subcontroller, problematic critical point(s) during the training may be avoided or escaped, and/or, when near the locus of global minima, an optimum with better generalization may be determined.

Additionally, when a regularizer switch is activated, one or more secondary terms of the loss function may be modified. Notably, when the regularizer switch is deactivated, the loss function used during the training may be unchanged. However, when the regularizer switch is activated, a given one of multiple modifications to the one or more secondary terms of the loss function may be used. For example, the loss function may have had no explicit regularizing terms, and when the switch is activated the trace of the Hessian matrix of the loss function may be added to the loss function as an explicit regularizer.

Alternatively, when the regularizer switch has been activated, under predefined conditions the regularizer switch may subsequently be deactivated. When this occurs, the loss function may revert to the original loss function. Furthermore, once the loss function switch is set, another subset of training cases may be processed (operation 512) and the loop may be repeated until a predefined criterion is met for the training to terminate (operation 520). At that point, the test data may then be optionally processed by the neural network (operation 522). By selectively activating/deactivating the regularizer switch in the loss function subcontroller, problematic critical point(s) during the training may be avoided or escaped, and/or, when near the locus of global minima, an optimum with better generalization may be determined.

Alternatively or additionally, during training of the neural network, the termination switch (operation 518) may initially be off (or in an off position). When the termination one or more criteria are fully met during the training, this switch may be turned on. The one or more criteria may include one or more measures of the local geometry of the loss function. When the termination switch is off, the training process may continue. However, when the termination switch is turned on (or transitions to an on position), the training process may terminate and the values of the weights of the neural network at that time may be saved (e.g., the values of the weights may be stored in memory) as the output weights of the trained neural network. Therefore, in these embodiments, the training may be governed or controlled by the termination switch. Note that in some embodiments, the computer system may respond to not reaching the termination criteria after a certain time or investment of resources by using a measure of the local geometry to modify the position in the loss landscape, or by an additional modification of the hyperparameters of the training process.

The evaluation switch (operation 524) may initially be in the off position or state during training. After training the neural network, the evaluation switch may be optionally turned on, which may cause an evaluation process to run or be executed. Notably, one or more measures of the local geometry of the loss function may optionally be incorporated into a resulting quality rating of the trained neural network. Once this quality rating has been computed, the evaluation switch may be turned off again and the trained neural network, along with the quality rating may be stored, displayed and/or provided to the user.

In summary, when training the neural network, one or more switches in one or more subcontrollers executed by the computer system may dynamically and selectively modify one or more first hyperparameters. Notably, when a given switch is activated according to one or more given predefined condition(s) (such as a given threshold), the associated hyperparameter in the one or more first hyperparameters may be modified. Moreover, when the given switch is subsequently deactivated according to one or more given second predefined condition(s) (such as the given threshold or a given second threshold, e.g., when there is hysteresis in the activation and the deactivation of the given switch), the hyperparameter in the one or more first hyperparameters may revert to its original value or setting. In general, the predefined condition(s) may include one or more measures or approximation measures (such as a combination of two or more measures or approximation measures), including: a measure corresponding to (or a function of) the local geometry of the loss landscape at or proximate to the current location of the neural network in the loss landscape; the number of iterations or cycles in the training; the training progress (such as the current training error or test error); a number of iterations or cycles that have elapsed since a previous modification of one or more of the first hyperparameters; and/or another measure. Note that the dynamic adapting may be performed automatically by the computer system. However, in other embodiments, the computer system may provide a recommended modification (e.g., on a display) for evaluation and selective approval by a user or an operator of the computer system.

Moreover, the training of the neural network may be governed or controlled by the initiation, termination, and evaluation switches. As noted previously, the initiation switch may initially be in the off position. Before training can begin, the initiation switch may be turned on, thereby activating the initialization process. Once this process is completed, the initiation switch may be turned off again, and the training switch may be turned on. Furthermore, the termination switch may initially be in the off position, and when it is turned on, the training process may be terminated and the training of the neural network may be completed. Additionally, during training, the evaluation switch may be turned off. Once the training is terminated, and when the computer system has been instructed to provide a quality rating for the trained neural network, the evaluation switch may be turned on, activating the evaluation process. Additionally, once the evaluation process is completed, the assessment switch may be turned off again.

In some embodiments of method 400 (FIG. 4) and/or 500, there may be additional or fewer operations. For example, in some embodiments, the dynamic adapting may include multiple consecutive instances in which a given hyperparameter is increased (or decreased), as opposed to turning a given modification on or off. Thus, in some embodiments, the given hyperparameter may be increased (or decreased) and then increased (or decreased) again. Furthermore, the order of the operations may be changed, and/or two or more operations may be combined into a single operation.

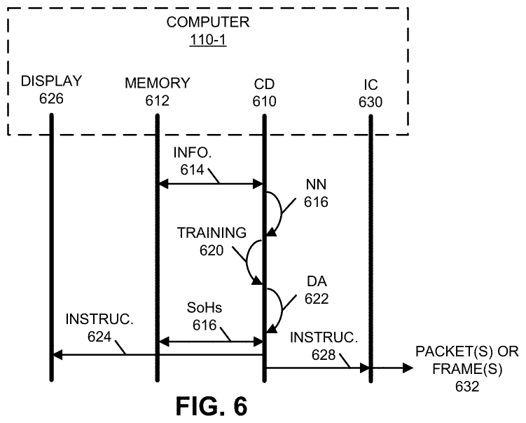

Embodiments of the training techniques are further illustrated in FIG. 6, which presents a drawing illustrating an example of communication among components in computer system 100. In FIG. 6, a computation device (CD) 610 (such as a processor or a GPU) in computer 110-1 may access in memory 612 in computer 110-1 information 614 specifying data (such as training data, test data and/or validation data), a set of one or more hyperparameters 616 (SoHs) and an architecture or a configuration of a neural network (NN) 618. Based at least in part on the one or more hyperparameters 616 (SoHs) and an architecture or a configuration, computation device 610 may implement the neural network 618.

Then, computation device 610 may perform training 620 of neural network 620. Moreover, during training 620, computation device 610 may dynamically adapt (DA) 622 one or more hyperparameters in the set of hyperparameters 618 based at least in part on a measure corresponding to a local geometry of a loss landscape at or proximate to a current location in the loss landscape.

After or while performing the training, computation device 610 may store results in memory 612, such as the set of one or more hyperparameters 616. Alternatively or additionally, computation device 610 may provide instructions 624 to a display 626 in computer 110-1 to display the results. In some embodiments, computation device 610 may provide instructions 628 to an interface circuit (IC) 630 in computer 110-1 to provide one or more packets or frames 632 with the results to another computer or electronic device (not shown).

While FIG. 6 illustrates communication between components using unidirectional or bidirectional communication with lines having single arrows or double arrows, in general the communication in a given operation in this figure may involve unidirectional or bidirectional communication.

We now further describe embodiments of the training techniques. In existing training techniques, the hyperparameters that govern the training process are typically chosen before the training process begins. For example, the hyperparameters may be chosen to have a fixed value during the training, or to change according to a predefined schedule during the training.

In the disclosed training techniques, one or more of the hyperparameters that govern the training process (such as the type or variation of stochastic gradient descent, the gradient, the learning rate or step size, the batch size, and/or the loss function) may be dynamically varied or adapted in real time as the training is performed. Notably, the one or more hyperparameters may be adjusted based at least in part on information about a local geometry of a loss landscape at or proximate (e.g., in a vicinity of) a current location of the neural network in the loss landscape (such as a current location corresponding to or a function of current weights of the neural network). As the training progresses, and the neural network moves through the loss landscape, the local geometry may change, and the one or more hyperparameters may evolve in response to those changes.

This capability may address both the optimization problem and the generalization problem that occur during training. Notably, adapting the one or more hyperparameters as the loss landscape is being traversed may result in more-efficient optimization, using fewer iterations or cycles of the training process, and may facilitate the discovery of solutions that generalize better (and, thus, which provide improved results, such as improved accuracy of the neural network).

Each time a neural network is trained, even using the same dataset and using the same architecture, the training path in the loss landscape may be different. Therefore, the disclosed training techniques may result in a different evolution of one or more first hyperparameters, in some or each time, in response to the local geometry of the loss landscape along the training path. In existing training techniques, hyperparameters may be the same in different iterations of training, or similar, even though the training trajectory may vary in different iterations of training.

As an analogy, existing training techniques are often like flying a plane by choosing the altitude, speed, and direction at each time during the flight ahead of time, and then proceeding as planned. In contrast, the disclosed training techniques are like flying a plane by starting with a flight plan, and adjusting the altitude, speed, and direction at each time in response to the local conditions. As with flying a plane, training a neural network while updating the one or more hyperparameters dynamically during training in response to the local geometry of the loss landscape may be more efficient and may provide improved results.

In some embodiments, the dynamic adapting of the one or more hyperparameters is based at least in part on one or more measures of the local geometry of the loss landscape. These measures may include or correspond to: the local slope, and/or the curvature. For example, the local slope may be determined directly by computing a slope associated with a loss function, a norm of a gradient, a norm of a directional derivative, and/or a first order measure of the local geometry. Alternatively or additionally, the local slope may be estimated indirectly, such as by looking at the magnitude of the change in the training error over the previous k iterations or cycles, where k is a non-zero integer.

Moreover, the curvature may be determined directly by computing the Hessian matrix, an approximation to the Hessian matrix or quantities derived from the Hessian matrix, such as the trace and/or the determinant of the Hessian matrix. Alternatively or additionally, the curvature may be estimated indirectly, such as by sampling nearby or proximate locations or points in the loss landscape (such locations within 1-10% of the current location or using 2, 4, 8, 16, 32, 64, 128, 256, or 512 nearby points) and then using this information to calculate an estimate of the curvature.

As discussed previously, a variety of hyperparameters may be dynamically adapted using the training techniques. For example, the one or more hyperparameters may include the type of variant of stochastic gradient descent. Stochastic gradient descent (SGD) is an iterative technique for optimizing an objective function with suitable smoothness properties (e.g., differentiable or subdifferentiable). It can be regarded as a stochastic approximation of gradient descent optimization, because it may replace the actual gradient (calculated from the entire dataset) by an estimated gradient (which may be calculated from a randomly selected subset of the data). In high-dimensional optimization problems, this may reduce the computational burden, achieving faster iterations in exchange for a slower convergence rate. There are many variations on stochastic gradient descent including: adaptive moment estimation (ADAM), batch normalization, AdaGrad (with parameter-specific learning rates), stochastic gradient descent using clipped gradients, and the training technique used may include any of these and/or another variation of stochastic gradient descent. Thus, in the training techniques, the type or variation of stochastic gradient descent may be changed from ADAM to batch normalization.

Moreover, the one or more hyperparameters may include the batch size. Note that when the batch is one, the learning technique used during the training of the neural network may be stochastic gradient descent. Alternatively, when the batch size is more than one sample and less than the size of the training dataset, the learning technique may be referred to as mini-batch gradient descent. In the disclosed training techniques, the batch size may be dynamically varied during the training.

Furthermore, the one or more hyperparameters may include the learning rate or step size. For example, in stochastic gradient descent, the step taken may be the gradient times the learning rate. In contrast with existing training techniques (in which the step size or learning rate may varying during the training according to a predefined schedule or a predefined scaling factor), in the disclosed training techniques the step size or the learning rate may be dynamically adapted during the training, as informed by one or more measures of the local geometry of the loss landscape at the present or current location.

Additionally, the one or more hyperparameters may include a primary term of the loss function. In existing training techniques, the loss function may be selected or defined at the start of the training and may not be subsequently changed during the training. In contrast, in the disclosed training techniques, the loss function may be dynamically varied or changed during the training. For example, as illustrated previously, the loss function may be dynamically changed from L2 norm to L1 norm (or vice versa).

Alternatively or additionally, one or more hyperparameters may include one or more secondary terms of the loss function. In the disclosed training techniques, the one or more secondary terms of the loss function may be dynamically varied or changed during the training. For example, the strength of one or more regularization terms in the loss function may be dynamically varied, a regularization term may be dynamically added to the loss function, and/or a regularization term may be dynamically removed from the loss function

In the following illustrative examples, the one or more hyperparameters are switched on or off (and, more generally, dynamically changed) during the training based at least in part on one or more measures of or corresponding to the local geometry of the loss landscape. Note that the described dynamic changes may be applied individually or in combination with each other (such as two or more dynamical changes that may be used together). For example, the dynamic adapting may change: the type or variation of stochastic gradient descent, the step size or the learning rate, the batch size, the primary term of the loss function and/or one or more regularizing terms in the loss function.

As noted previously, a variety of one or more measures may be used to determine when to dynamically adapt the one or more hyperparameters. For example, the one or more measures may include or may approximate the local slope. This may be determined directly by computing a slope associated with a loss function, a norm of a gradient, a norm of a directional derivative, and/or a first order measure of the local geometry. Alternatively or additionally, the local slope may be estimated indirectly, such as by looking at the change in the training error over the previous k iterations or cycles, where k is a non-zero integer.

In some embodiments, the one or more hyperparameters may be dynamically changed when: the magnitude of the gradient drops below i, where i is a value between 0 and 0.05; the slope in the average direction of the last k steps is less than j, where k is between 10 and 100 and j is a value between 0 and 0.05; the change in the training error over the previous I iterations or cycles drops below p, where p is a value between 0 and 0.001 and I is a value between 10 and 10,000; and/or the change in the training error over the previous I iterations or cycles drops below q percent of the average training error in the previous I iterations or cycles, where q is a value between 0 and 0.2. For example, if the average training error in the previous 1,000 steps is 0.2, and q is chosen to be 0.5, then when the training error decreases by less than 0.001 (or 0.1%) over the previous I iterations or cycles, the dynamic adapting of the one or more hyperparameters may occur.

Moreover, the one or more measures may include or may approximate the curvature. This may be determined directly by computing the Hessian matrix or quantities derived from the Hessian matrix, such as the trace or the determinant of the Hessian matrix. Alternatively or additionally, the curvature may be estimated indirectly, such as by sampling proximate or nearby points and using this information to calculate an estimate of the curvature.

In some embodiments, the one or more hyperparameters may be dynamically changed when: the trace of the Hessian l, where l is a value between 0 and 0.1; the average eigenvalue of the Hessian (which is sometimes referred to as the mean curvature) drops below m, where m is a value between 0 and 0.001; the operator norm of the Hessian (or, equivalently the magnitude of the largest eigenvalue of the Hessian) drops below n, where n is a value between 0 and 0.1; and/or an estimated mean curvature (which may be computed by sampling nearby points) drops below r, where r is a value between 0 and 0.001.

Note that in some embodiments different measures or criteria may be used to determine when to dynamically adapt at least one of the one or more hyperparameters relative to a remainder of the one or more hyperparameters. In some embodiments, the dynamic-adaptation criteria for each of the one or more hyperparameters may be different. Alternatively, at least two of the one or more hyperparameters may share or may have the same dynamic-adaptation criterion.

Furthermore, in some embodiments, the dynamic adapting of a given one of the one or more hyperparameters may be selectively disabled or deactivated. For example, the dynamic adapting of the given one of the one or more hyperparameters may be selectively disabled or deactivated when the given hyperparameter is not dynamically changed for a predefined number of iterations of cycles s (such as 10,000 or 100,000 iterations or cycles). Moreover, the dynamic adapting of the given one of the one or more hyperparameters may be selectively disabled or deactivated after the local slope increases above a threshold. This threshold may, in general, be different than the threshold at which the dynamic adapting of the given one of the one or more hyperparameters occurred.

For example, the dynamic adapting of the given one of the one or more hyperparameters may be selectively disabled or deactivated when the local curvature increases above a second threshold. This second threshold may, in general, be larger than the threshold at which the dynamic adapting of the given one of the one or more hyperparameters occurred. In some embodiments, the dynamic adapting of the given one of the one or more hyperparameters may be selectively disabled after a criterion involving two or more of the aforementioned factors occurs. For example, the dynamic adapting of the given one of the one or more hyperparameters may be selectively disabled after: 10,000 gradient iterations or cycles have been taken and the local curvature is larger than 0.2; or 100,000 gradient iterations or cycles have been taken (whichever happens first).

We now describe examples of hyperparameter modification(s) when one or more measure-based criteria occur. For example, the dynamic adapting of the type or variation of stochastic gradient descent that is used may occur when a measure of the local geometry of the loss landscape reaches or crosses a threshold. For example, when the measure is less than (or, in other embodiments, greater than) the threshold, a modified gradient descent may be used instead of the standard gradient. Thus, instead of making updates according to

x→x+η∇L,

the updates may be made according to

$$x \to x + η \frac{∇ L}{‖ ∇ L ‖} .$$

Moreover, the dynamic adapting of the learning rate of the step size may occur when a measure of the local geometry of the loss landscape reaches or crosses a second threshold. For example, as long as the measure is less than (or, in other embodiments, greater than) the second threshold, a modified gradient descent may be used with an increased step size or learning rate.

Furthermore, the dynamic adapting of the batch size may occur when a measure of the local geometry of the loss landscape reaches or crosses a third threshold. For example, as long as the measure is less than (or, in other embodiments, greater than) the third threshold, a modified gradient descent may be used with a decreased or reduced batch size.

Additionally, the dynamic adapting of the primary term of the loss function may occur when a measure of the local geometry of the loss landscape reaches or crosses a fourth threshold. For example, as long as the measure is less than (or, in other embodiments, greater than) the fourth threshold, the primary term of the loss function may be changed or may be different from the previous term. In some embodiments, if the loss function that is being used initially has an L2 loss or L2 norm, then it may be replaced with a corresponding L1-loss or L1-norm term.

In some embodiments, the dynamic adapting of one or more secondary terms of the loss function may occur when a measure of the local geometry of the loss landscape reaches or crosses a fifth threshold. For example, as long as the measure is less than (or, in other embodiments, greater than) the fifth threshold, a regularizing term of the loss function may be added to the loss function. Notably, if a loss function L is being used, then L may be selectively replaced (as long as the measure is less than (or, in other embodiments, greater than) the fifth threshold) by L+ϵ·tr(H(L)), where tr(H(L)) is the trace of the Hessian of L and ϵ is a number between 0 and 1. Moreover, in this example, gradient descent may then be based on the new loss function (instead of L).

We now describe an example of the training techniques. In some embodiments, a user may want to train an optimized neural network (GpuNet) that distinguishes 1.2 million high-resolution images in an ImageNet dataset (from the Stanford Image Lab, Stanford University, Stanford, Calif.) into 1,000 different classes. The neural network may have 60 million parameters associated with 650,000 neurons, which are arranged in fully connected layers, convolutional layers, and max-pooling layers.

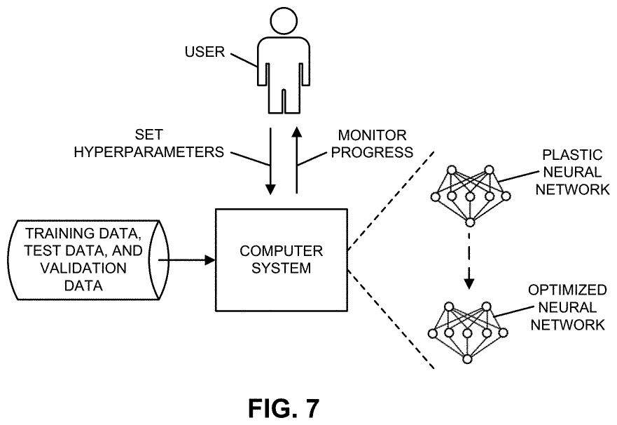

As shown in FIG. 7, which illustrates an example of training a neural network, in an existing training technique training data, validation data and test data may be compiled. Notably, starting from the ImageNet dataset (which may include 15 million labeled, high-resolution images belonging to roughly 22,000 categories), training data, validation data and test data may be curated in several ways. For example, a subset of the images may be selected, such as approximately 1,000 images in each of 1,000 categories. These images may be divided into 1.2 million training images, 50,000 validation images, and 150,000 test images. Then, the training data may be processed using data-augmentation techniques, such as adding translations and reflections of the images in the training data to the training data.

Next, the neural network may be initialized. For example, the weights may be initialized using a Gaussian distribution with a mean of zero and a standard deviation of 0.01. Moreover, a set of hyperparameters for training may be selected, such as: a type or variation of stochastic gradient descent (e.g., ADAM), a batch size (e.g., 128), a learning rate or a step size, and/or an optional regularizer that is included in the loss function. In some embodiments, the learning rate may be initialized at 0.01, and may be reduced by a scaling factor of 10 when the validation error rate stops improving with a current value of the learning rate. When the learning rate has been reduced 3 times, the training of the neural network may terminate. Alternatively, the training of the neural network may continue until the validation error stops decreasing.

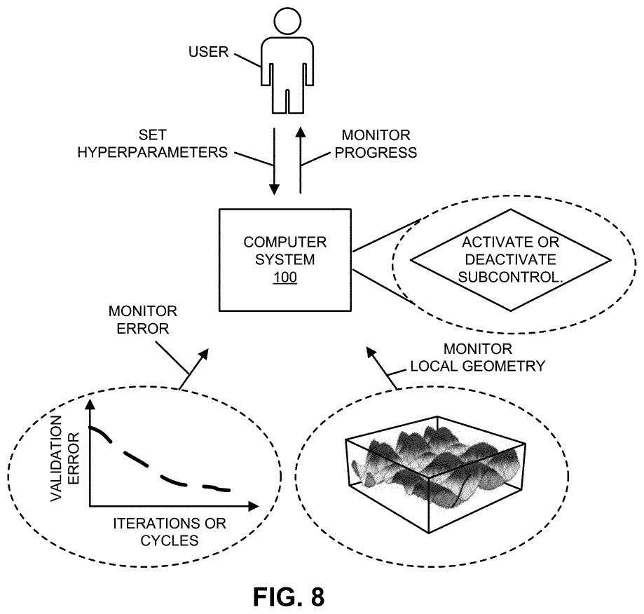

Alternatively, as shown in FIGS. 7 and 8, which illustrates an example of training a neural network, in the disclosed training techniques training data and test data may be compiled. Once again, starting from the ImageNet dataset, training data, validation data and test data may be curated in several ways. For example, a subset of the images may be selected, such as approximately 1,000 images in each of 1,000 categories. These images may be divided into 1.2 million training images, 50,000 validation images, and 150,000 test images. Then, the training data may be processed using data-augmentation techniques, such as adding translations and reflections of the images in the training data to the training data.

Next, the neural network may be initialized. For example, the weights may be initialized using a Gaussian distribution with a mean of zero and a standard deviation of 0.01. Moreover, a set of hyperparameters for training may be selected, such as: a type or variation of stochastic gradient descent (e.g., stochastic gradient descent), a batch size (e.g., 128), a learning rate or a step size, and/or an optional regularizer that is included in the loss function. In some embodiments, the learning rate may be initialized at 0.01. The training of the neural network may continue until the test error is less than 1%.

In some embodiments of the disclosed training techniques, the step size may decrease monotonically as a function of time during the training. However, in other embodiments, the step size may be locally increased, e.g., for a number of iterations or cycles. Nonetheless, at the end of the training, the goal may be for the step size to be small.

Moreover, subcontrollers may be selected to use during the training of the neural network including thresholds at which these subcontrollers are activated or deactivated, and the settings of the subcontrollers. In this example, the subcontrollers may include a batch size subcontroller and a step size subcontroller (i.e., the one or more first hyperparameters may include the batch size and the step size or the learning rate). In some embodiments, the step size subcontroller may include two parts working in conjunction, a base step size subcontroller and a step size modification subcontroller. (Note that a similar approach may be used for one or more of the other subcontrollers.) The thresholds or condition(s) for the batch size subcontroller and the step size subcontroller may be defined as follows.

In some embodiments, the base step size subcontroller may be on for the entire training process. For example, the base step size may be initialized at 0.01, and the base step size subcontroller may decrease the step size by a factor of 10 if the training error in the past 10,000 iterations or cycles has decreased by less than 2% and the base step size has not been changed in the past 10 million iterations or cycles. However, independently of the base step size subcontroller, the step size modification subcontroller may act to increase or decrease the step size.

When the training error is much larger than zero (e.g., more than 5%):

If in the past 10,000 iterations or cycles, the training error at the previous iteration or cycle is greater than 99% of the training error at the first iteration or cycle, the batch size subcontroller may be activated. When the batch size subcontroller is activated, the batch size may be decreased to 32. Moreover, while the batch size subcontroller is activated, the training error may be monitored for the next 100,000 iterations or cycles. If at any point during 10,000 iteration or cycle subsets of the 100,000 iterations or cycles, the training error at the previous iteration or cycle is less than 99% of the training error at the first iteration or cycle, the batch size subcontroller may be deactivated. This may return the batch size to the original batch size of 128.

Alternatively, if the training error does not drop by at least 1% in any period of 10,000 iterations or cycles in the 100,000 iterations or cycles, the batch size subcontroller may be deactivated and the step size modification subcontroller may be activated. When the step size modification subcontroller is activated, the learning rate or step size may be increased by a factor of 20 from a current learning rate or step size. Moreover, while the step size subcontroller is activated, the training error may be monitored for 100,000 iterations or cycles.

If, in the past 10,000 iterations or cycles in the 100,000 iterations or cycles, the training error at the previous iteration or cycle is less than 99% of the training error at the first iteration or cycle, the step size modification subcontroller may be deactivated. This may return the step size or the learning rate to the default value of the base step size controller according to the stage of training. However, as noted previously, if the training error does not drop by at least 1% in any period of 10,000 iterations or cycles in the 100,000 iterations or cycles, the batch size subcontroller may be deactivated and the step size subcontroller may be activated.

The preceding operations may be repeated as above for up to five iterations. If the training error does not decrease meaningfully (such as by at least 1%), the training may be terminated the training of the neural network may be repeated from the start (e.g., reinitialize and restart the training process).

When the training error is close to zero (such as less than 5%):

If in the past 10,000 iterations or cycles, the training error at the previous iteration or cycle is greater than 99.9% of the training error at the first iteration or cycle, the batch size subcontroller may be activated. When the batch size subcontroller is activated, the batch size may be decreased to 32. Moreover, while the batch size subcontroller is activated, the training error may be monitored for 100,000 iterations or cycles, and the test error may be checked every 1,000 iterations or cycles.

If, in the past 10,000 iterations or cycles in the 100,000 iterations or cycles, the training error at the previous iteration or cycle is less than 99.8% of the training error at the first iteration or cycle, the batch size subcontroller may be deactivated. This may return the batch size to 128.

Alternatively, if the training error does not drop by at least 0.2% in any period of 10,000 iterations or cycles in the 100,000 iterations or cycles, the batch size subcontroller may be deactivated and the step size modification subcontroller may be activated. When the step size modification subcontroller is activated, the step size or the learning rate may be increased by a factor of 20 from the current step size or learning rate. Moreover, while the step size subcontroller is activated, the training error may be monitored for 100,000 iterations or cycles.

If, in the past 10,000 iterations or cycles in the 100,000 iterations or cycles, the training error at the previous iteration or cycle is less than 99% of the training error at the first iteration or cycle, the step size modification subcontroller may be deactivated. This may return the step size or the learning rate to the default value of the base step size according to the stage of training. However, as noted previously, if the training error does not drop by at least 0.2% in any period of 10,000 iterations or cycles in the 100,000 iterations or cycles, the batch size subcontroller may be deactivated and the step size modification subcontroller may be activated.

Furthermore, if the test error reaches a threshold of 1%, the training may be terminated. However, if the test error has not reached this threshold, the preceding operations may be repeated up to 10 times. Thus, the training may be terminated if the test error reaches the aforementioned threshold or the preceding operations have been repeated 10 times. Regarding the training until the test error stops decreasing, note that this is relative to the total test error. For example, if the training error is 22%, and we are looking for a decrease of 1% over 10,000 iterations or cycles, we are looking for an absolute decrease of 0.22%. Note that the step size may be reduced to a minimum value before the training of the neural network is terminated.

The disclosed training techniques may provide several advantages over the existing training techniques. There is typically a lot of randomness during training of neural networks, so the number of iterations or cycles needed to train a neural network even with a fixed dataset and fixed architecture may vary significantly with each training attempt. However, on average, when trained using the disclosed training techniques, a smaller number of training iterations or cycles (such as at least 1-10% fewer iterations or cycles) may be needed to obtain an optimized neural network with the same test error compared with in the existing training techniques.

Similarly, the generalization error of the optimized neural network may vary significantly between training attempts, even with a fixed dataset and fixed architecture. However, the disclosed training techniques, on average, produces an optimized neural net that generalizes better (e.g., 5, 15 or 35% better) than in the existing training techniques.

Moreover, when training a neural network, the training procedure may sometimes be impeded because the path of training gets stuck near a local minimum or a saddle point with positive training error. In other words, while traversing the loss landscape using a gradient-based technique, the path may come too close to a critical point that is far from a global minimum and the training may get stuck because the gradient-based technique cannot escape the neighborhood of that critical point. In the existing training techniques, at this point the training process may need to be terminated and the entire training process may need to be started again with a new initialization.

However, in the disclosed training techniques, when the training trajectory approaches such a critical point, one or more of the subcontrollers may be automatically activated. In many cases, the dynamic adjusting of the one or more first hyperparameters governing the training may modify the training process in such a way that it becomes possible for the path to leave the neighborhood of the problematic critical point, and for training to continue (with the one or more first hyperparameters reverting to their original values after some number of iterations or cycles) without abandoning the training attempt and re-starting the training process.

Similarly, when training a neural network, the training procedure may sometimes produce suboptimal results because the path of training converges near a global minimum but one which does not generalize well. In the existing training techniques, at this point the training process may need to be terminated and the entire training process may need to be started again with a new initialization.

However, in the disclosed training techniques, when the training trajectory approaches such an undesirable global minimum, one or more of the subcontrollers may be automatically activated. In some embodiments, the dynamic adjusting of the one or more first hyperparameters governing the training may modify the training process in such a way that it becomes possible for the path to leave the neighborhood of the undesirable global minimum, and for training to continue (with the one or more first hyperparameters reverting to their original values after some number of iterations or cycles) without abandoning the training attempt and restarting the training process. In these embodiments, this dynamic adjustment may make it possible for the training process to discover a different global minimum that generalizes better.

In existing training techniques, it is often necessary to create a neural network and to populate it with initial values or weights prior to beginning the training process. Existing approaches for generating initial values include drawing random values from a distribution, or drawing random values from a distribution by group of weights with an additional scaling on each group depending on the geometry of the neural network.

In the disclosed training techniques, after an initialization has been created, measures of the local geometry of the loss function at that initial location may be considered. Depending on the outcome, the initialization may be discarded and a new initialization attempted. For example, one or more criteria for discarding an initialization may be that a number of positive eigenvalues of the Hessian matrix exceeds a threshold (such as a value between 20% and 80% of a total number of eigenvalues of the Hessian matrix). Alternatively or additionally, another of the one or more criteria for discarding an initialization may be that an average magnitude of the largest 10 negative eigenvalues of the Hessian matrix may be less than a threshold (such as a value between 1 and 1,000). Moreover, yet another of the one or more criteria for discarding an initialization may be that a ratio between an average magnitude of the 10 largest positive sectional curvatures and an average magnitude of the 10 largest negative sectional curvatures may be smaller than a threshold (such as a value between 0.1 and 2). In some embodiments, one of the one or more criteria for discarding an initialization may be that a magnitude of a gradient at the initialization is less than a threshold (such as a value between 0.1 and 10).

Furthermore, in the disclosed training techniques, using measures of the local geometry of the loss function in the pre-training operation may produce better initial positions at which to start training, and may result in a shorter and less computationally expensive training period, as well as increased probability that the training process terminates in a high-quality solution (such as a neural network with improved performance).

In existing training techniques, it is often necessary to specify when the training process should be terminated. For example, the one or more criteria for termination of training may include: the training loss dropping below a threshold, the validation loss dropping below a second threshold, and/or the execution of a certain number of gradient steps.

In the disclosed training techniques, the one or more criteria for termination of training may include one or more criteria that do not involve measures of the local geometry of the loss function, such as the validation loss dropping below a threshold and/or one or more criteria involving measures of the local geometry of the loss function. For example, the training process may terminate when one or more criteria or conditions are met, including: at least 1,000 training epochs have taken place since the training loss first dropped below a threshold of 2%; a ratio of the average of the largest or top 30% of magnitudes of eigenvalues of the Hessian to the average of the smallest or bottom 30% of magnitudes of eigenvalues of the Hessian rises above 10,000; or a current largest sectional curvature is less than half of the largest value of the largest sectional curvature over the last 10,000 gradient steps. Alternatively or additionally, the training process may terminate when one or more criteria or conditions are met, including: a validation loss is less than 3% and the trace of the Hessian drops below 0.03·d, where d is the dimension of the loss surface.

In the disclosed training techniques, utilizing measures of the local geometry of the loss function in the one or more criteria for termination of the training process may: improve or optimize the amount of time spent training, and/or improve or maximizing a quality of the resulting neural network while reducing or minimizing the amount of time and computing power spent training. The training techniques may improve a quality or a performance of the output neural network by helping or facilitating the selection of weights that result in a neural network that generalizes well, is robust to noise, and/or that is stable when faced with adversarial examples.

Additionally, in existing training techniques, the trained neural network may be accompanied with a quality rating that estimates a quality of the trained neural network where the rating may correspond to accuracy, robustness, and/or stability of the neural network. This quality rating may be created by considering factors that may include: an error rate of the neural network on the test data set, an error rate of the neural network on adversarial examples, and/or a sparsity of the weights.

In the disclosed training techniques, the creation of the quality rating may involve combine inputs that do not involve measures of the local geometry of the loss function with inputs that involve measures of the local geometry of the loss function. For example, the quality rating may be computed as 100·(an error rate of the neural network on the test data set) plus the average magnitude of the 10 largest eigenvalues of a Hessian matrix. For this quality rating, the lower the value of the quality rating, the higher the projected quality of the neural network. In another example, the quality rating may be computed as the average distance of an input test data point from a decision boundary plus an inverse of a trace of the Hessian matrix. In these embodiments, the higher the value of the quality rating, the higher the projected quality of the neural network. In some embodiments, the three largest sectional curvatures at the final location in the loss landscape may be computed by the computer system and provided as the quality rating. In these embodiments, a lower value of the quality rating may indicate an improved quality of the neural network. Alternatively, a fraction of eigenvalues of the Hessian matrix that are less than one may be computed at the final location in the loss landscape, and may be combined with a measure based at least in part on performance on test data and a second measure based at least in part on a geometry of the decision boundary as the quality rating. For this quality rating, a lower value of the quality rating may indicate an improved quality of the neural network.

Moreover, in the disclosed training techniques, using measures of the local geometry of the loss function as inputs to the quality rating for the trained neural network may provide more useful quality ratings that provide better projections for how well the neural network will perform in real life. The disclosed training techniques may provide a quality rating more rapidly and/or with less computational expense than existing approaches, and thus may reduce the use of resources in a computer system that performs the training techniques.

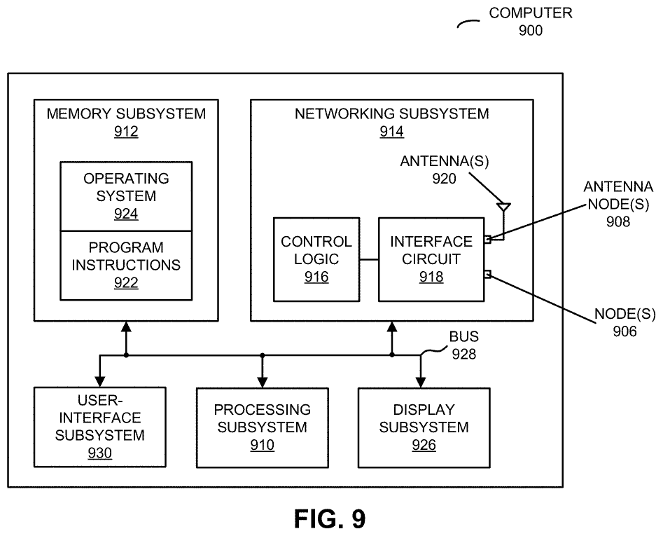

We now describe embodiments of a computer, which may perform at least some of the operations in the training techniques. FIG. 9 presents a block diagram illustrating an example of a computer 900, e.g., in a computer system (such as computer system 100 in FIG. 1), in accordance with some embodiments. For example, computer 900 may include: one of computers 110. This computer may include processing subsystem 910, memory subsystem 912, and networking subsystem 914. Processing subsystem 910 includes one or more devices configured to perform computational operations. For example, processing subsystem 910 can include one or more microprocessors, ASICs, microcontrollers, programmable-logic devices, GPUs and/or one or more DSPs. Note that a given component in processing subsystem 910 are sometimes referred to as a ‘computation device’.

Memory subsystem 912 includes one or more devices for storing data and/or instructions for processing subsystem 910 and networking subsystem 914. For example, memory subsystem 912 can include dynamic random access memory (DRAM), static random access memory (SRAM), and/or other types of memory. In some embodiments, instructions for processing subsystem 910 in memory subsystem 912 include: program instructions or sets of instructions (such as program instructions 922 or operating system 924), which may be executed by processing subsystem 910. Note that the one or more computer programs or program instructions may constitute a computer-program mechanism. Moreover, instructions in the various program instructions in memory subsystem 912 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 910.

In addition, memory subsystem 912 can include mechanisms for controlling access to the memory. In some embodiments, memory subsystem 912 includes a memory hierarchy that comprises one or more caches coupled to a memory in computer 900. In some of these embodiments, one or more of the caches is located in processing subsystem 910.

In some embodiments, memory subsystem 912 is coupled to one or more high-capacity mass-storage devices (not shown). For example, memory subsystem 912 can be coupled to a magnetic or optical drive, a solid-state drive, or another type of mass-storage device. In these embodiments, memory subsystem 912 can be used by computer 900 as fast-access storage for often-used data, while the mass-storage device is used to store less frequently used data.

Networking subsystem 914 includes one or more devices configured to couple to and communicate on a wired and/or wireless network (i.e., to perform network operations), including: control logic 916, an interface circuit 918 and one or more antennas 920 (or antenna elements). (While FIG. 9 includes one or more antennas 920, in some embodiments computer 900 includes one or more nodes, such as antenna nodes 908, e.g., a metal pad or a connector, which can be coupled to the one or more antennas 920, or nodes 906, which can be coupled to a wired or optical connection or link. Thus, computer 900 may or may not include the one or more antennas 920. Note that the one or more nodes 906 and/or antenna nodes 908 may constitute input(s) to and/or output(s) from computer 900.) For example, networking subsystem 914 can include a Bluetooth™ networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, and/or another networking system.

Networking subsystem 914 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, computer 900 may use the mechanisms in networking subsystem 914 for performing simple wireless communication between electronic devices, e.g., transmitting advertising or beacon frames and/or scanning for advertising frames transmitted by other electronic devices.

Within computer 900, processing subsystem 910, memory subsystem 912, and networking subsystem 914 are coupled together using bus 928. Bus 928 may include an electrical, optical, and/or electro-optical connection that the subsystems can use to communicate commands and data among one another. Although only one bus 928 is shown for clarity, different embodiments can include a different number or configuration of electrical, optical, and/or electro-optical connections among the subsystems.

In some embodiments, computer 900 includes a display subsystem 926 for displaying information on a display, which may include a display driver and the display, such as a liquid-crystal display, a multi-touch touchscreen, etc. Moreover, computer 900 may include a user-interface subsystem 930, such as: a mouse, a keyboard, a trackpad, a stylus, a voice-recognition interface, and/or another human-machine interface.

Computer 900 can be (or can be included in) any electronic device with at least one network interface. For example, computer 900 can be (or can be included in): a desktop computer, a laptop computer, a subnotebook/netbook, a server, a supercomputer, a tablet computer, a smartphone, a cellular telephone, a consumer-electronic device, a portable computing device, communication equipment, and/or another electronic device.

Although specific components are used to describe computer 900, in alternative embodiments, different components and/or subsystems may be present in computer 900. For example, computer 900 may include one or more additional processing subsystems, memory subsystems, networking subsystems, and/or display subsystems. Additionally, one or more of the subsystems may not be present in computer 900. Moreover, in some embodiments, computer 900 may include one or more additional subsystems that are not shown in FIG. 9. Also, although separate subsystems are shown in FIG. 9, in some embodiments some or all of a given subsystem or component can be integrated into one or more of the other subsystems or component(s) in computer 900. For example, in some embodiments program instructions 922 are included in operating system 924 and/or control logic 916 is included in interface circuit 918.

Moreover, the circuits and components in computer 900 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 914 and/or computer 900. The integrated circuit may include hardware and/or software mechanisms that are used for transmitting signals from computer 900 and receiving signals at computer 900 from other electronic devices. Aside from the mechanisms herein described, radios are generally known in the art and hence are not described in detail. In general, networking subsystem 914 and/or the integrated circuit may include one or more radios.

In some embodiments, an output of a process for designing the integrated circuit, or a portion of the integrated circuit, which includes one or more of the circuits described herein may be a computer-readable medium such as, for example, a magnetic tape or an optical or magnetic disk or solid state disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the training techniques may be implemented using program instructions 922, operating system 924 (such as a driver for interface circuit 918) or in firmware in interface circuit 918. Thus, the training techniques may be implemented at runtime of program instructions 922. Alternatively or additionally, at least some of the operations in the training techniques may be implemented in a physical layer, such as hardware in interface circuit 918.

In the preceding description, we refer to ‘some embodiments’. Note that ‘some embodiments’ describes a subset of all of the possible embodiments, but does not always specify the same subset of embodiments. Moreover, note that the numerical values provided are intended as illustrations of the training techniques. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
a computation device;
memory configured to store program instructions, wherein, when executed by the computation device, the program instructions cause the computer system to perform one or more operations comprising:
choosing or selecting one or more criteria for when to terminate training of a neural network, wherein the one or more criteria are based at least in part on a measure corresponding to a local geometry of a loss landscape at or proximate to a current location in the loss landscape during the training.

2. The computer system of claim 1, wherein the operations comprise:
training the neural network based at least in part on a set of hyperparameters, wherein the training comprises computing weights associated with neurons in the neural network; and
terminating the training of the neural network based at least in part on the one or more criteria.

3. The computer system of claim 1, wherein the one or more criteria comprise: a trace of a Hessian matrix associated with a loss function dropping below a threshold, or a ratio between an operator norm of the Hessian matrix and a curvature of the loss function at the current location in the loss landscape reaching or exceeding a second threshold.

4. The computer system of claim 3, wherein the loss function comprises a training error of the neural network and values of the loss function specify the loss landscape at or proximate to the current location.

5. The computer system of claim 1, wherein the operations comprise computing values of a loss function at or proximate to the current location based at least in part on one or more outputs from the neural network.

6. The computer system of claim 5, wherein the loss function comprises a training error of the neural network and the computed values of the loss function specify the loss landscape at or proximate to the current location.

7. The computer system of claim 1, wherein the measure comprises: a slope at the current location along one or more dimensions in the loss landscape, or a curvature at the current location along the one or more dimensions in the loss landscape.

8. The computer system of claim 7, wherein the slope comprises a derivative or a batched gradient at the current location.

9. The computer system of claim 1, wherein the measure comprises an approximation to: a slope associated with a loss function, a norm of a gradient, a norm of a directional derivative, or a first order measure of the local geometry.

10. The computer system of claim 1, wherein the measure comprises an approximation to: a Hessian matrix associated with a loss function, a trace of the Hessian matrix, an eigenvalue of the Hessian matrix, or an operator norm of the Hessian matrix.

11. A non-transitory computer-readable storage medium for use in conjunction with a computer system, the computer-readable storage medium configured to store program instructions that, when executed by the computer system, causes the computer system to perform one or more operations comprising:
choosing or selecting one or more criteria for when to terminate training of a neural network, wherein the one or more criteria are based at least in part on a measure corresponding to a local geometry of a loss landscape at or proximate to a current location in the loss landscape during the training; and
training the neural network based at least in part on a set of hyperparameters, wherein the training comprises computing weights associated with neurons in the neural network.

12. The non-transitory computer-readable storage medium of claim 11, wherein the operations comprise terminating the training of the neural network based at least in part on the one or more criteria.

13. The non-transitory computer-readable storage medium of claim 11, wherein the one or more criteria comprise: a trace of a Hessian matrix associated with a loss function dropping below a threshold, or a ratio between an operator norm of the Hessian matrix and a curvature of the loss function at the current location in the loss landscape reaching or exceeding a second threshold.

14. The non-transitory computer-readable storage medium of claim 11, wherein the measure comprises: a slope at the current location along one or more dimensions in the loss landscape, or a curvature at the current location along the one or more dimensions in the loss landscape.

15. A method for training a neural network, comprising:
by a computer system:
choosing or selecting one or more criteria for when to terminate training of the neural network, wherein the one or more criteria are based at least in part on a measure corresponding to a local geometry of a loss landscape at or proximate to a current location in the loss landscape during the training; and
training the neural network based at least in part on a set of hyperparameters, wherein the training comprises computing weights associated with neurons in the neural network.

16. The method of claim 15, wherein the method comprises terminating the training of the neural network based at least in part on the one or more criteria.

17. The method of claim 15, wherein the one or more criteria comprise: a trace of a Hessian matrix associated with a loss function dropping below a threshold, or a ratio between an operator norm of the Hessian matrix and a curvature of the loss function at the current location in the loss landscape reaching or exceeding a second threshold.

18. The method of claim 15, wherein the measure comprises: a slope at the current location along one or more dimensions in the loss landscape, or a curvature at the current location along the one or more dimensions in the loss landscape.

19. The method of claim 15, wherein the measure comprises an approximation to: a slope associated with a loss function, a norm of a gradient, a norm of a directional derivative, or a first order measure of the local geometry.

20. The method of claim 15, wherein the measure comprises an approximation to: a Hessian matrix associated with a loss function, a trace of the Hessian matrix, an eigenvalue of the Hessian matrix, or an operator norm of the Hessian matrix.
